(19) United States
(12) Patent Application Publication
(10) Pub. No.: US 2004/0170333 A1
(43) Pub. Date: Sep. 2, 2004

(54) Method and device for coding successive images

(76) Inventors: Tuukka Toivonen, Oulu (FI); Janne Heikkila, Oulu (FI); Olli Silven, Oulu (FI)

Correspondence Address: LADAS & PARRY, 26 WEST 61ST STREET, NEW YORK, NY, 10023, US

(21) Appl. No.: 10/487,124

(22) PCT Filed: Sep. 4, 2002
(86) PCT No.: PCT/FI02/00711

(30) Foreign Application Priority Data
Sep. 6, 2001 (FI) 20011766

(51) Int. Cl. G06K 9/36; H04B 1/66

(52) U.S. Cl. 382/236; 375/240.12

(57) ABSTRACT

The invention relates to a method and device for coding successive images. The method comprises defining (600) a search area in a reference image; and computing (602) the cost function of each motion vector candidate. Then, the block to be coded is coded (614) by using the motion vector candidate giving the lowest cost function value. In the computation (602) of the cost function, number-theoretic transform is performed (604, 606) for the block to be coded and for the candidate block; multiplication is performed (608) between the block to be coded and the transformed candidate block; correlation between the block to be coded and the candidate block is formed (610) by performing inverse transform of number-theoretic transform for the result of the multiplication; and the correlation formed is used (612) in the computation of the cost function.

### FIELD

The invention relates to a method and device for coding successive images.

### BACKGROUND

Coding of successive images, for instance a video image, is used for reducing the amount of data so as to be able to store it more efficiently in a memory means or to transfer it by using a data link. An example of a video coding standard is MPEG-4 (Moving Pictures Expert Group). There are different image sizes, the cif size being 352×288 pixels and the qcif size 176×144 pixels, for instance.

Typically, an individual image is divided into blocks, the size of which is selected to be suitable for the system. A block usually comprises information on luminance, colour and location. The block data is compressed block-specifically with a desired coding method. Compression is based on deleting data that is less significant. Compression methods are primarily divided into three categories: spectral redundancy reduction, spatial redundancy reduction and temporal redundancy reduction. Typically, different combinations of these methods are used for the compression.

In order to reduce spectral redundancy, for instance the YUV colour model is used. The YUV colour model utilizes the fact that the human eye is more sensitive to variation in luminance than to variation in chrominance changes, i.e. colour changes. The YUV model has one luminance component (Y) and two chrominance components (U, V). For instance, the luminance block according to the H.263 video coding standard is 16×16 pixels, and both chrominance blocks, covering the same area as the luminance block, are 8×8 pixels. The combination of one luminance block and two chrominance blocks is called a macro block. Each pixel, both in the luminance and chrominance blocks, can obtain a value between 0 and 255, in other words eight bits are required for representing one pixel. For instance, the value 0 of the luminance pixel denotes black and the value 255 denotes white.

In order to reduce spatial redundancy, for example discrete cosine transform (DCT) is used. In discrete cosine transform, the pixel representation of the block is transformed into a space frequency representation. In addition, in the image block, only those signal frequencies that are present in it have high-amplitude coefficients, and those signals that are not present in the block have coefficients close to zero. The discrete cosine transform is in principle a lossless transform, and the signal is subjected to interference only in quantization.

Temporal redundancy is reduced by utilizing the fact that successive images usually resemble each other; so instead of compressing each individual image, motion data of the blocks is generated. This is called motion compensation. A previously coded reference block that is as good as possible is searched for the block to be coded in a reference image stored in the memory previously, the motion between the reference block and the block to be coded is modelled, and the computed motion vectors are transmitted to a receiver. The dissimilarity of the block to be coded and the reference block is expressed as an error factor. Such coding is called inter-coding, which means utilization of similarities between the images in the same image sequence.

In this application, the emphasis is on the problems of finding the best motion vectors. Typically, a search area is determined for the reference image, from which search area a block similar to that in the present image to be coded is searched. The best match is found by computing the cost function, for instance the sum of absolute differences (SAD), between the pixels of the block in the search area and the block to be coded.

In accordance with the prior art, full search has been used; in other words, all or almost all possible motion vectors have been set as candidates for the motion vector. Full search is also known as the abbreviation ESA (Exhaustive Search Algorithm). The problem in using full search is the large number of computations required. For example, if the size of the search area is 48×48 pixels, whereby the number of possible motion vectors at the accuracy of one pixel is 32×32 and the size of the luminance block is 16×16 pixels, the total of 16×16=256 computations are required for the computation of one sum of absolute differences, and the total of 32×32×256=262 144 computations per macro block are required for the computation of the sum of absolute differences of all possible motion vectors. For example, an image of the cif size has 396 macro blocks, in other words there are 396×262 144=103 809 024 computations. A video image usually comprises 15 images per second, whereby the number of computations required per second is 15×103 809 024=155 713 5360, just for finding the motion vectors.

There have been attempts to reduce the number of computations by using different search methods in which the number of motion vector candidates is radically reduced. For instance, in the TSS (Three Step Search) method, sums of absolute differences are computed from different parts of the search area only for eight motion vectors during three different rounds, reducing the search area on each round, whereby the number of computations is reduced to 3×8×256=6144 computations per one macro block. The motion vector giving the best result is then selected for continuation, and a smaller search area is formed around it, from which the best motion vector is then searched. The problem in this solution is that the search area is smaller than in the full search and that if the search begins to follow a wrong track at the first stage, the method gives a poor result.

Other methods in which the number of computations is reduced at the cost of the image quality include TDL (2-D Log Search), Cross Search and 1-D Full Search. Non-deterministic methods in which the number of computations varies according to the image to be coded include SEA (Successive Elimination Algorithm) and PDE (Partial Distortion Elimination).

U.S. Pat. No. 5,535,288, incorporated as reference herein, discloses a method giving as good a result as full search, with less computation. In accordance with the convolution theorem, convolution and correlation can be computed with Fourier transforms. The Fourier transforms used are the problem of the solution, as their computation requires the use of floating point arithmetics and two-component complex numbers. Implementation of the computations in question, particularly by using application-specific integrated circuits (ASIC), is inefficient, which causes an increase in power consumption in devices using such circuits. The problem is particularly great in multimedia terminals of radio systems, for example mobile phone systems.

### BRIEF DESCRIPTION

An object of the invention is to provide an improved method and an improved device. As an aspect of the invention there is provided the method according to claim 1. As an aspect of the invention there is provided the device according to claim 13. Other preferred embodiments of the invention are disclosed in the dependent claims.

The invention is based on the idea that the Fourier transforms are replaced with number-theoretic transforms, the processing of which requires only the use of one-component integers.

The solution according to the invention facilitates implementation of efficient application-specific integrated circuits, particularly for multimedia terminals.

### LIST OF FIGURES

Preferred embodiments of the invention are described by way of example with reference to the attached drawings, of which:

FIG. 1 shows devices for coding and decoding video image;

FIG. 2 shows in more detail a device for coding video image;

FIG. 3 shows two successive images, there being the present image to be coded on the left and a reference image on the right;

FIG. 4 shows details of FIG. 3 enlarged, there being in addition a motion vector found;

FIGS. 5 and 6 are flow charts illustrating a method of coding video image;

FIG. 7 shows flipping the block to be coded in the horizontal direction and in the vertical direction;

FIG. 8 shows formation of correlation;

FIG. 9 is a flow chart illustrating computation of a cost function by using a 48-point Winograd Fourier Transformation algorithm adapted for a number-theoretic transform.

### DESCRIPTION OF EMBODIMENTS

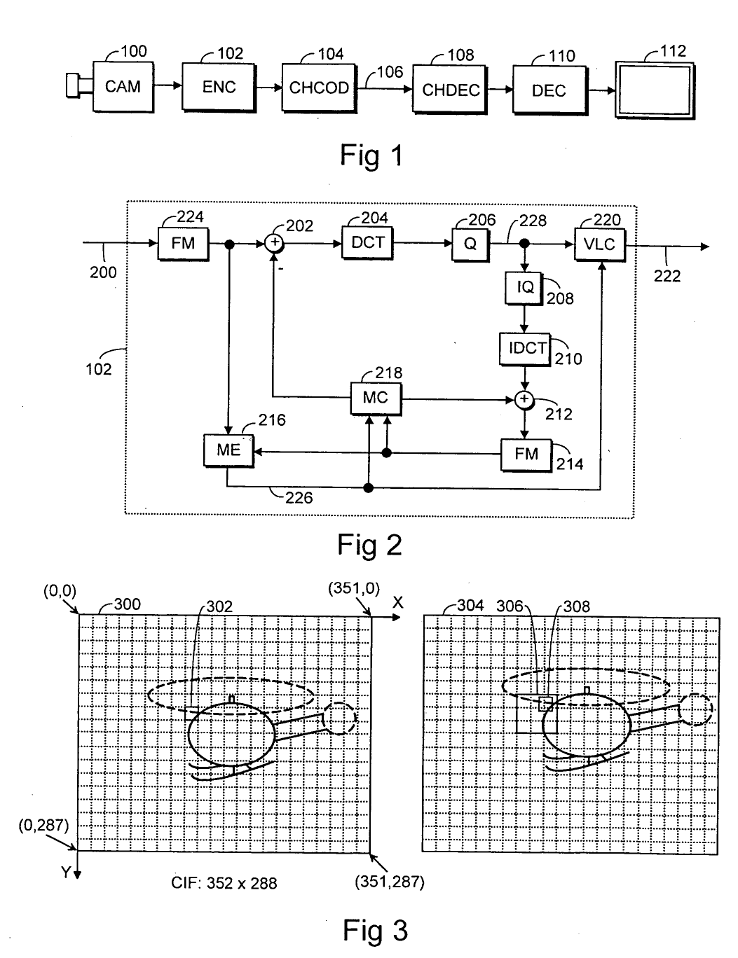

With reference to FIG. 1, devices for coding and decoding video image are described. The description is simplified, because video coding is well-known to a person skilled in the art on the basis of standards and textbooks, for instance on the basis of the work incorporated as reference herein: Vasudev Bhaskaran and Konstantinos Konstantinides: ‘Image and Video Compressing Standards—Algorithms and Architectures, Second Edition’, Kluwer Academic Publishers 1997, Chapter 6: ‘The MPEG video standards’. A video image is formed of individual successive images in a camera 100. With the camera 100, a matrix is formed that represents the image in pixels, for instance in the way described at the beginning where the luminance and chrominance have their own matrices. The data flow representing the image in pixels is taken to an encoder 102. Naturally, such a device can also be constructed where the data flow can be received in the encoder 102 for instance along a data transmission connection or from a memory means of a computer. Thus, it is the intention that the uncompressed video image is compressed with the encoder 102, for instance for forwarding or storing. The compressed video image formed with the encoder 102 is transferred to a decoder 108 by using a channel 106.

In the encoder 102, each block is discrete-cosine-transformed and quantized, i.e. in principle each element is divided by a constant. The constant can vary between different macro blocks. The quantization parameter, from which the divisors are computed, is usually between 1 and 31. The more zeros are got in a block, the better the block is compressed, because no zeros are transmitted to the channel. Different coding methods can further be performed for the quantized blocks, and finally a bit stream is formed of them and transmitted to a decoder 110. Inverse quantization and inverse discrete cosine transform are still performed for the quantized blocks inside the encoder 102, forming thus a reference image from which blocks of the following images can be predicted. After this, the encoder transmits difference data between the incoming block and reference blocks, as well as motion vectors. In this way, the compression efficiency is improved. After the decompression of the bit stream and compression methods, the decoder 110 does, in principle, the same as the encoder 102 did when the reference image was formed; in other words, the same operations are performed for the blocks as in the encoder 102, but in the inverse order.

It is not described herein how the channel 106 is implemented, because the different implementation options are clear to a person skilled in the art. The channel 106 can be for example a fixed or a wireless data transmission connection. The channel 106 can also be interpreted as a transmission path, by means of which the video image is stored in a memory means, for instance on a laser disk, and by means of which the video image is then read from the memory means and processed with the decoder 108. Also other coding can be performed for the compressed video image to be transferred in the channel 106, for example with a channel encoder 104 shown in FIG. 1. The channel encoding is decoded with the channel decoder 108. The video image formed of still images and decoded with the decoder 110 can be shown on a display 112.

The encoder 102 and the decoder 110 can be positioned in different devices, for example in computers, in subscriber terminals of different radio systems, such as in mobile stations, or in other devices in which it is desirable to process video image. The encoder 102 and the decoder 110 can also be combined into the same device that can, in such cases, be called a video codec.

FIG. 2 shows in more detail a device for coding a video image, i.e. the encoder 102. A moving video image 200 is brought into the encoder 102, and it can be stored temporarily image by image in a frame buffer 224. The first image is what is called an intra image, in other words no coding is performed for it to reduce temporal redundancy, although it is processed in a discrete cosine transform block 204 and in a quantization block 206. Even after the first image, intra images can be transmitted if, for example, no sufficiently good motion vectors are found.

When the following images are processed, coding for reducing temporal redundancy can be started. In such a case, the reference image is inverse-quantized in an inverse quantization block 208 and also inverse discrete cosine transform is performed for it in an inverse discrete cosine transform block 210. If a motion vector has been computed for the preceding image, its effect is added to the image with means 212. In this way, the reconstructed previous image is stored in the frame buffer 214, i.e. the previous image in such a form where it is after the processing performed in the decoder 110. Thus, there may be two frame buffers, a first one 224 for storing the present image from the camera and a second one 214 for storing the reconstructed previous image.

The previous reconstructed image is then taken from the frame buffer 214 to a motion estimation block 216. In the same way, the present image to be coded is taken to the motion estimation block 216. In the motion estimation block 216, a search is then performed for reducing temporal redundancy, the intention being to find such blocks in the previous image that correspond to the blocks in the present image. The displacements between the blocks are expressed as motion vectors.

The motion vectors found are taken to a motion compensation block 218 and to a variable-length encoder 220. Also the previous reconstructed image from the frame buffer 214 is taken to the motion compensation block 218. On the basis of the previous reconstructed image and motion vector, the compensation block 218 knows how to transmit the block found in the previous image to the means 202 and 212. The block found in the previous image is subtracted from the present image to be coded with the means 202, more precisely from at least one block thereof. Thus, an error factor remains to be coded from the present image, more precisely from at least one block thereof, the error factor being discrete-cosine-transformed and quantized.

Hence, the variable-length encoder 220 receives the discrete-cosine-transformed and quantized error factor 228 and the motion vector 226 as inputs. Thus, compressed data representing the present image is got from the output 222 of the encoder 102, the compressed data representing the present image relative to the reference image by using a motion vector or motion vectors and an error term or error terms for the representation. Motion estimation is performed by using luminance blocks, but the error factors to be coded are computed for both the luminance and chrominance blocks.

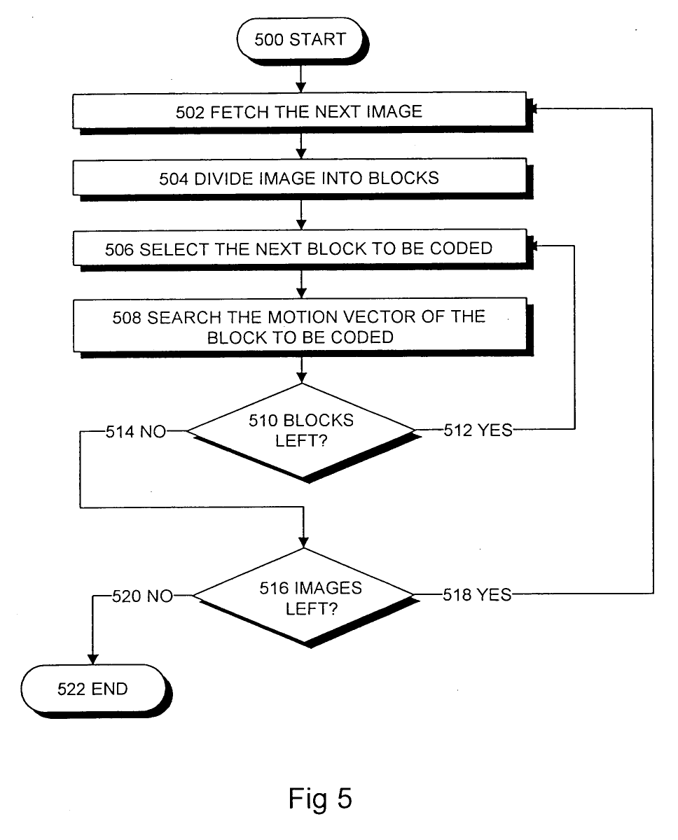

Next, with reference to the flow chart of FIG. 5, a method of coding successive images is described. Coding is described specifically from the point of view of reducing temporal redundancy and no other methods for reducing redundancy are described in this context. Implementation of the method is started in a block 500, in which the encoder 102 encodes the first intra image. In a block 502, the next image is fetched from the frame memory 224. In a block 504, the image to be coded is divided into blocks, for instance the cif image is divided into 396 macro blocks. In a block 506, the next block to be coded is selected. Then, in a block 508, the motion vector of the block to be coded is searched. In a block 510, it is tested whether there are any blocks to be coded left. If there are blocks to be coded, one moves on to the block 506 in accordance with arrow 512. If there are no blocks to be coded, one moves on to a block 516 in accordance with arrow 514. In the block 516, it is tested whether there are any images to be coded left. If there are images to be coded, one moves on to the block 502 in accordance with arrow 518. If there are no images to be coded, one moves on, in accordance with arrow 520, to the block 522 where the method is completed.

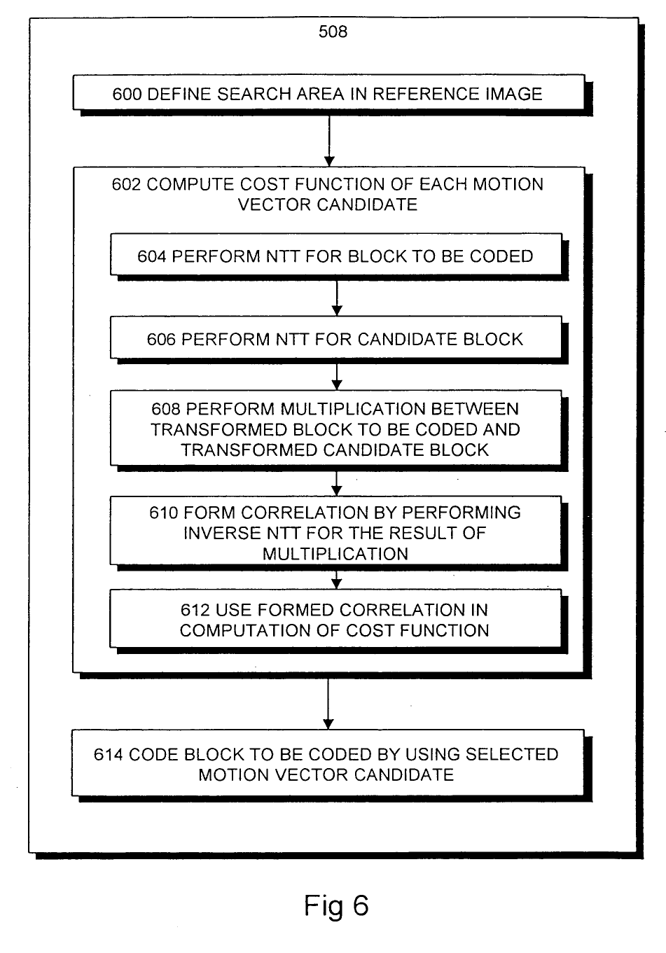

In FIG. 6, the content of the block 508 of FIG. 5 is described in more detail, i.e. the search for the motion vector of the block to be encoded. In a block 600, the search area is defined for the reference image, from which area the block to be coded in the present image is searched. The reference image may be the image immediately preceding the image to be coded or one of the images preceding the image to be coded.

FIG. 3 illustrates two successive still images; in other words there is a present image 300 to be coded on the left and a reference image 304 on the right. The images are of the cif size, i.e. they have 22×18=396 luminance macro blocks, each of a size of 16×16 pixels. The chrominance blocks are usually of a size of 8×8 pixels, but they are not shown in FIG. 3, because no chrominance blocks are utilized in the estimation of the motion vector.

It is assumed that in the image 300 to be coded, a block 302 is the one to be coded. In the reference image 304, a search area 306 of a size of 48×48 pixels is formed around the block 302 to be coded. The size of the search area is in our example of a size of nine blocks. Thus, the number of possible motion vectors, i.e. motion vector candidates, is 32×32.

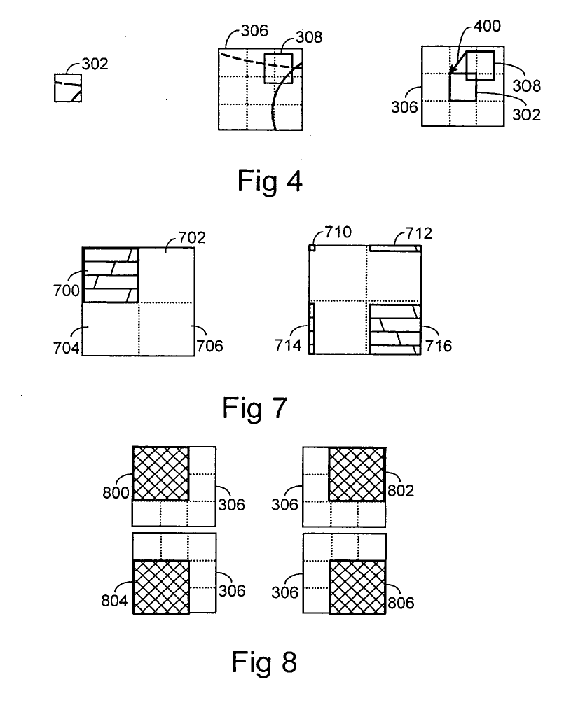

In the search area 306, a block 308 is then found that corresponds to the block 302 to be coded. In FIG. 4, from the left edge onwards, the block 302, the search area 306 and the block 308 corresponding to the block 302 to be coded are shown enlarged. In FIG. 4, the image element on the right is a combination image showing the location of the block 302 to be coded in the search area 306 as well as the found block 308 corresponding to the block 302 to be coded.

The motion of the block 302 to be coded relative to the block 308 found in the reference image 304 is expressed by a motion vector 400. The motion vector can be expressed as the motion vector of the pixel in the leftmost upper corner of the block 302 to be coded. Naturally, other pixels in the block also move in the direction of the motion vector in question.

The origin (0, 0) of the image is usually the pixel in the leftmost upper corner of the image. In the video coding terminology, movements are expressed in such a way that motion to the right is positive, to the left negative, upwards negative and downwards positive. The coordinates in the left upper corner of the block 302 to be coded are thus (128, 112). The coordinates in the left upper corner of the search area 306 are (112, 96). The motion vector 400 is (−10, 10), i.e. the motion is 10 pixels in the direction of the X axis to the left and 10 pixels in the direction of the Y axis downwards.

From the block 600, one moves on to a block 602, where the cost function of each motion vector candidate is computed, the motion vector candidate determining the motion between the block 302 to be coded and the candidate block 308. Thus, full search is used here, in other words the cost functions of all motion vector candidates are defined.

The SSD (Sum of Squared Differences) function is used as the cost function, its formula being

$$SSD ( x , y ) = {\sum }_{k = 0}^{15} {\sum }_{l = 0}^{15} {[ {F}_{t} ( k , l ) - {F}_{t - 1} ( x + k , y + l ) ]}^{2} , \\ where ( x , y ) ∈ [ 0 , 32 ] \qquad ( 1 )$$

Formula 1 can be extended to three terms:

$$\begin{matrix}{\sum }_{k = 0}^{15} {\sum }_{l = 0}^{15} {{F}_{i} ( k , l )}^{2} & ( 2 ) \\ + {\sum }_{k = 0}^{15} {\sum }_{l = 0}^{15} {{F}_{t - 1} ( x + k , y + l )}^{2} & ( 3 ) \\ - 2 {\sum }_{k = 0}^{15} {\sum }_{l = 0}^{15} {F}_{t} ( k , l ) {F}_{t - 1} ( x + k , y + l ) & ( 4 )\end{matrix}$$

Term 2 is constant and does not have to be computed, because we are not interested in the minimum value of the SSD function but in finding the values of x and y with which the SSD function receives the minimum value.

Term 3 can, in accordance with the prior art, be computed differentially with relatively simple operations, for example as in the publication incorporated as reference herein: Yukihiro Naito, Takashi Miyazaki, Ichiro Kuroda: A fast full-search motion estimation method for programmable processors with a multiply-accumulator, IEEE International Conference on Acoustics, Speech, and Signal Processing, 1996.

Term 4 is correlation that is computed in the way described in the following. In a block 604, number-theoretic transform is performed for the block to be coded. Then in a block 606, number-theoretic transform is performed for the candidate block. Next, in a block 608, multiplication is performed between the block to be transformed and the transformed candidate block. In a block 610, the correlation is formed of the block to be coded and the candidate block by performing inverse transform of the number-theoretic transform for the result of the multiplication. In accordance with a block 612, the correlation formed is used in the computation of the cost function, i.e. as term 4 in Formula 1.

The number-theoretic transform (NTT) is defined as follows:

$${X}_{k} ≡ {\sum }_{n = 0}^{N - 1} {x}_{n} {ω}^{kn} ( mod q ) , k = 0 , 1 , … , N - 1 , \qquad ( 5 )$$

where χₙ are N integers to be transformed between 0 and q−1 (the limits being included), ω is the kernel of the transform, i.e. a well-selected integer between 0 and q−1, and Xₖ are the integers received as a result of the transform between 0 and q−1. All operations are performed modulo q.

The inverse transform of the number-theoretic transform is defined:

$${x}_{n} ≡ {N}^{- 1} {\sum }_{n = 0}^{N - 1} {K}_{k} {ω}^{- kn} ( mod q ) , k = 0 , 1 , … , N - 1 , \qquad ( 6 )$$

where N⁻¹ is the number-theoretic inverse of N in such a way that

N·N⁻¹≡(mod q) (7)

and correspondingly, ω⁻¹ is the number-theoretic inverse of ω. It is preferable but not necessary that modulus q is a prime number.

Since the values of the pixels vary between 0 and 255, the correlation values can be

$${\sum }_{k = 0}^{15} {\sum }_{l = 0}^{15} 255 \cdot 255 = 16646400$$

at the maximum, which is slightly smaller than 224, in other words 24 bits are sufficient to represent the value of q.

Finally, in a block 614, the block 302 to be coded is coded by using the motion vector 400 giving the lowest value of the cost function.

In one embodiment, the number-theoretic transform is implemented by using the Radix-2 algorithm or the Winograd Fourier Transformation algorithm (WFTA). Since these algorithms are well known to those skilled in the art, the use thereof is not described in more detail herein. The use of the Radix-2 algorithm is described in, for example, the article incorporated as reference herein: William T. Cochran et al: What is the Fast Fourier Transform, in Digital filters and the fast Fourier transform, ISBN 0-470-53150-4. When these algorithms are used, the following values give good results; the modulus of the number-theoretic transform is 16777217 and the kernel 524160, or the modulus is 16777217 and the kernel 65520, or the modulus is 4294967297 and the kernel 4, or the modulus is 4294967297 and the kernel 3221225473.

In one embodiment, the block 302 to be coded in the computation of the cost function is padded to the size where one pixel corresponds to each motion vector candidate by adding zero elements. This gives linear correlation. In the way illustrated by FIG. 7, our example contains 32×32 motion vector candidates, the size of the block 700 to be coded being 16×16 pixels; in other words, 16 rows are added below to the block to be coded and 16 columns of zero elements are added to the right-hand side, i.e. three blocks 702, 704, 706 of zero elements. The number-theoretic transform of the block to be coded is first performed for the leftmost half of all columns and after that for all rows, i.e. in our examples first for 16 left-hand side columns and after that for all 32 rows. Linear correlation is required for computing term 4, but in accordance with the convolution theorem, cyclic convolution would be received. Correlation is received by flipping the transformed block 700 to be coded in the horizontal direction and in the vertical direction, which gives the block shown on the right in FIG. 7, the block 700 to be coded being divided into four blocks 710, 712, 714, 716. In our example, the block 700 is, in principle, the same as the previous block 302, but different lines are drawn inside it to illustrate the effect of the flip on the content of the block 700. Next, at least four transformed candidate blocks are selected. This is illustrated in FIG. 8, which shows the search area 306 and candidate blocks 800, 802, 804, 806 in it. It is to be noted that these candidate blocks 800, 802, 804, 806 have not been padded with zeros, but that their size is nevertheless 32×32 pixels. The blocks 800, 802, 804, 806 are selected appropriately overlapped in such a way that one fourth of the area of each block 800, 802, 804, 806 overlaps with the block 302 to be coded. Multiplication is performed for each candidate block 800, 802, 804, 806 in turn by the flipped, transformed block to be coded, and inverse transform of number-theoretic transform is performed for each result of the multiplication, the results of the inverse transform being combined into one correlation. In the transform domain, the multiplication between the blocks corresponds to cyclic correlation, but because of the cyclicity, the results of the multiplication contain folded erroneous data elsewhere except in the left corner of the spatial domain in the area of a size of 16×16 pixels. The inverse transform of number-theoretic transform is performed first for all rows and after that for the left half of all columns, i.e. in our example first for all 32 rows and after that for 16 left-hand side columns. The result of the combination is one 32×32 correlation matrix that contains the correlation value corresponding to each motion vector candidates.

Number-theoretic transform can also be implemented by using the 48-point Winograd Fourier Transformation algorithm adapted for number-theoretic transform. When this algorithm is used, the following values give good results: the modulus of the number-theoretic transform is 16777153 and the kernel is 4575581.

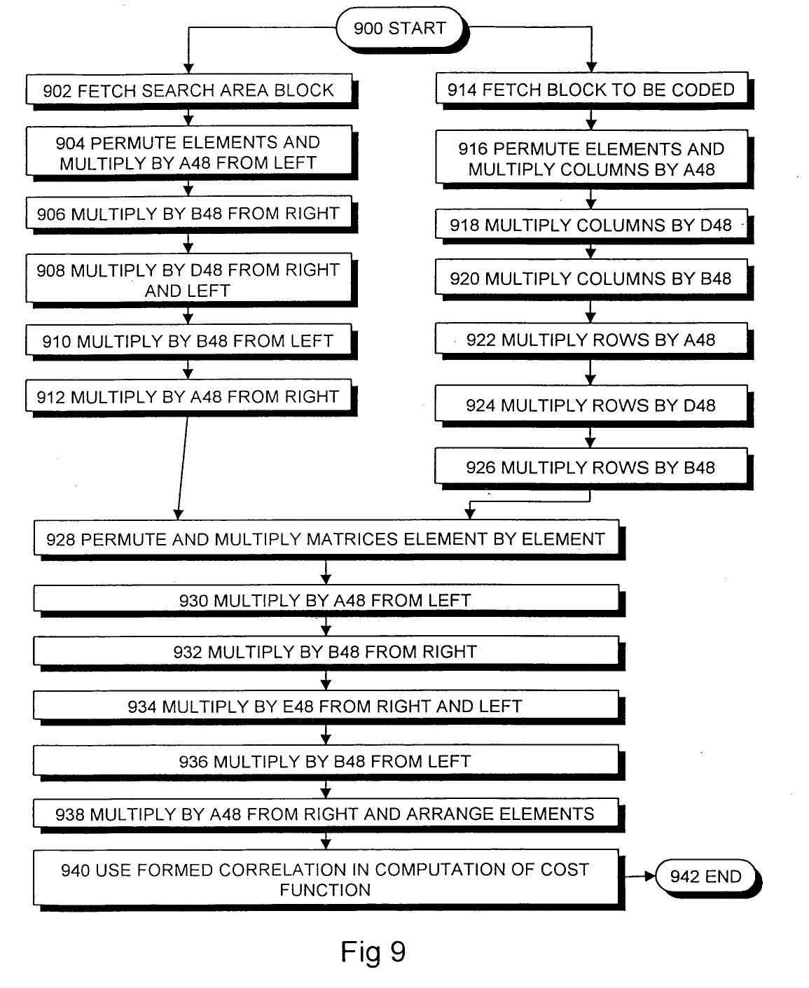

FIG. 9 illustrates computation of a cost function by using the 48-point Winograd Fourier Transformation algorithm adapted for number-theoretic transform. The function described is positioned inside the earlier-described block 508. Computation is started in a block 900 and completed in a block 942. Then the computation is divided into two parallel branches, the processing of which can be implemented as parallel computation. In the left branch, a search area block is processed, meaning the search area 306 of a size of 48×48 pixels described in FIG. 3. In the right branch, the block 302 to be coded shown in FIG. 3 is processed, which block is padded to be of a size of 48×48 pixels by adding zero elements.

In a block 902, a search area block of a size of 48×48 pixels is fetched and stored in a matrix of a size of 48×48 elements. In a block 904, each column and row of the matrix is permuted. Table 1 shows the location of the column and row of the original matrix in the left column and the new permuted location in the right column.

For example, the element of the matrix that is in the third column and second row (i.e. at location 2, 1, because the indices begin from zero, the column being denoted first) is moved first to column 34 when the columns are permuted. After this, when the rows are permuted, the element is moved to row 17. At the end, the element is thus at location 34, 17. All matrix elements are permuted in the corresponding way.

TABLE 1

| ORIGINAL | NEW |
|---|---|
| 0 | 0 |
| 33 | 1 |
| 18 | 2 |
| 3 | 3 |
| 36 | 4 |
| 21 | 5 |
| 6 | 6 |
| 39 | 7 |
| 24 | 8 |
| 9 | 9 |
| 42 | 10 |
| 27 | 11 |
| 12 | 12 |
| 45 | 13 |
| 30 | 14 |
| 15 | 15 |
| 16 | 16 |
| 1 | 17 |
| 34 | 18 |
| 19 | 19 |
| 4 | 20 |
| 37 | 21 |
| 22 | 22 |
| 7 | 23 |
| 40 | 24 |
| 25 | 25 |
| 10 | 26 |
| 43 | 27 |
| 28 | 28 |
| 13 | 29 |
| 46 | 30 |
| 31 | 31 |
| 32 | 32 |
| 17 | 33 |
| 2 | 34 |
| 35 | 35 |
| 20 | 36 |
| 5 | 37 |
| 38 | 38 |
| 23 | 39 |
| 8 | 40 |
| 41 | 41 |
| 26 | 42 |
| 11 | 43 |
| 44 | 44 |
| 29 | 45 |
| 14 | 46 |
| 47 | 47 |

In addition to permutation, the matrix is multiplied in the block 904 from the left by constant matrix A48 by using ordinary calculation rules for matrices. Matrix A48 is given in the following formula:

A48=A3\mathring{×}A16 (8)

where \mathring{×} is Kronecker product, i.e. tensor product, matrix A3 is

$$A3 = [ \begin{matrix}1 & 1 & 1 \\ 0 & 1 & 1 \\ 0 & 1 & - 1\end{matrix} ]$$

matrix A16 is

$$A16 = [ \begin{matrix}1 & 1 & 1 & 1 & 1 & 1 & 1 & 1 & 1 & 1 & 1 & 1 & 1 & 1 & 1 & 1 \\ 1 & - 1 & 1 & - 1 & 1 & - 1 & 1 & - 1 & 1 & - 1 & 1 & - 1 & 1 & - 1 & 1 & - 1 \\ 1 & 0 & - 1 & 0 & 1 & 0 & - 1 & 0 & 1 & 0 & - 1 & 0 & 1 & 0 & - 1 & 0 \\ 1 & 0 & 0 & 0 & - 1 & 0 & 0 & 0 & 1 & 0 & 0 & 0 & - 1 & 0 & 0 & 0 \\ 1 & 0 & 0 & 0 & 0 & 0 & 0 & 0 & - 1 & 0 & 0 & 0 & 0 & 0 & 0 & 0 \\ 0 & 1 & 0 & - 1 & 0 & - 1 & 0 & 1 & 0 & 1 & 0 & - 1 & 0 & - 1 & 0 & 1 \\ 0 & 0 & 1 & 0 & 0 & 0 & - 1 & 0 & 0 & 0 & - 1 & 0 & 0 & 0 & 1 & 0 \\ 0 & 1 & 0 & - 1 & 0 & 1 & 0 & - 1 & 0 & - 1 & 0 & 1 & 0 & - 1 & 0 & 1 \\ 0 & 1 & 0 & 0 & 0 & 0 & 0 & - 1 & 0 & - 1 & 0 & 0 & 0 & 0 & 0 & 1 \\ 0 & 0 & 0 & - 1 & 0 & 1 & 0 & 0 & 0 & 0 & 0 & 1 & 0 & - 1 & 0 & 0 \\ 0 & 1 & 0 & - 1 & 0 & 1 & 0 & - 1 & 0 & 1 & 0 & - 1 & 0 & 1 & 0 & - 1 \\ 0 & 0 & 1 & 0 & 0 & 0 & - 1 & 0 & 0 & 0 & 1 & 0 & 0 & 0 & - 1 & 0 \\ 0 & 0 & 0 & 0 & 1 & 0 & 0 & 0 & 0 & 0 & 0 & 0 & - 1 & 0 & 0 & 0 \\ 0 & 1 & 0 & 1 & 0 & - 1 & 0 & - 1 & 0 & 1 & 0 & 1 & 0 & - 1 & 0 & - 1 \\ 0 & 0 & 1 & 0 & 0 & 0 & 1 & 0 & 0 & 0 & - 1 & 0 & 0 & 0 & - 1 & 0 \\ 0 & 1 & 0 & 1 & 0 & 1 & 0 & 1 & 0 & - 1 & 0 & - 1 & 0 & - 1 & 0 & - 1 \\ 0 & 1 & 0 & 0 & 0 & 0 & 0 & 1 & 0 & - 1 & 0 & 0 & 0 & 0 & 0 & - 1 \\ 0 & 0 & 0 & 1 & 0 & 1 & 0 & 0 & 0 & 0 & 0 & - 1 & 0 & - 1 & 0 & 0\end{matrix} ]$$

For the sake of efficiency, the permutation and the multiplication by matrix A48 can be combined in such a way that no separate permutation is needed for the search area block.

In a block 906, the result of the block 904 is multiplied from the right by constant matrix B48 by using ordinary calculation rules for matrices. Matrix B48 is given in the following formula:

B48=B3\mathring{×}B16 (9)

where \mathring{×} is Kronecker product, matrix B3 is

$$B3 = [ \begin{matrix}1 & 0 & 0 \\ 1 & 1 & 1 \\ 1 & 1 & - 1\end{matrix} ]$$

and matrix B16 is

$$B16 = [ \begin{matrix}1 & 0 & 0 & 0 & 0 & 0 & 0 & 0 & 0 & 0 & 0 & 0 & 0 & 0 & 0 & 0 & 0 & 0 \\ 0 & 0 & 0 & 0 & 1 & 0 & 1 & - 1 & 1 & 0 & 0 & 0 & 1 & 0 & 1 & 1 & 1 & 0 \\ 0 & 0 & 0 & 1 & 0 & 1 & 0 & 0 & 0 & 0 & 0 & 1 & 0 & 1 & 0 & 0 & 0 & 0 \\ 0 & 0 & 0 & 0 & 1 & 0 & - 1 & 1 & 0 & - 1 & 0 & 0 & - 1 & 0 & 1 & 1 & 0 & - 1 \\ 0 & 0 & 1 & 0 & 0 & 0 & 0 & 0 & 0 & 0 & 1 & 0 & 0 & 0 & 0 & 0 & 0 & 0 \\ 0 & 0 & 0 & 0 & 1 & 0 & - 1 & - 1 & 0 & 1 & 0 & 0 & 1 & 0 & - 1 & 1 & 0 & - 1 \\ 0 & 0 & 0 & 1 & 0 & - 1 & 0 & 0 & 0 & 0 & 0 & - 1 & 0 & 1 & 0 & 0 & 0 & 0 \\ 0 & 0 & 0 & 0 & 1 & 0 & 1 & 1 & - 1 & 0 & 0 & 0 & - 1 & 0 & - 1 & 1 & 1 & 0 \\ 0 & 1 & 0 & 0 & 0 & 0 & 0 & 0 & 0 & 0 & 0 & 0 & 0 & 0 & 0 & 0 & 0 & 0 \\ 0 & 0 & 0 & 0 & 1 & 0 & 1 & 1 & - 1 & 0 & 0 & 0 & 1 & 0 & 1 & - 1 & - 1 & 0 \\ 0 & 0 & 0 & 1 & 0 & - 1 & 0 & 0 & 0 & 0 & 0 & 1 & 0 & - 1 & 0 & 0 & 0 & 0 \\ 0 & 0 & 0 & 0 & 1 & 0 & - 1 & - 1 & 0 & 1 & 0 & 0 & - 1 & 0 & 1 & - 1 & 0 & 1 \\ 0 & 0 & 1 & 0 & 0 & 0 & 0 & 0 & 0 & 0 & - 1 & 0 & 0 & 0 & 0 & 0 & 0 & 0 \\ 0 & 0 & 0 & 0 & 1 & 0 & - 1 & 1 & 0 & - 1 & 0 & 0 & 1 & 0 & - 1 & - 1 & 0 & 1 \\ 0 & 0 & 0 & 1 & 0 & 1 & 0 & 0 & 0 & 0 & 0 & - 1 & 0 & - 1 & 0 & 0 & 0 & 0 \\ 0 & 0 & 0 & 0 & 1 & 0 & 1 & - 1 & 1 & 0 & 0 & 0 & - 1 & 0 & - 1 & - 1 & - 1 & 0\end{matrix} ]$$

In a block 908, the result of the previous block is multiplied both from the right and from the left by diagonal matrix D48. The diagonal values depend on the transform kernel used. In this example, the kernel is 4575581, whereby the matrix is received from the following formula:

D48=D3\mathring{×}D16 (10)

where the diagonal values of matrix D3 are in Table 3 and the diagonal values of matrix D16 are in Table 4.

TABLE 3
1
8388575
12598629

Multiplication both from the left and from the right by a diagonal matrix corresponds to multiplication of each matrix element to be multiplied by a constant: in other words, each element in the matrix to be multiplied is multiplied by a constant two times successively. These two constants can be multiplied together in advance, whereby multiplication is saved per each element.

In a block 910, the result of the previous block is multiplied by matrix B48 from the left, and in a block 912, the result is multiplied with matrix A48 from the right. Operations performed after the permutation can be expressed mathematically by formula

y=B48·D48·A48·x·B48·D48·A48 (11)

where x is the permuted search area block and y is the result of a block 912. The result is number-theoretic transform of the search area block 306, except that the result is left in the permuted order.

TABLE 4
1
1
1
1
1
16179524
16179524
2445009
603766
4286252
8579524
8579524
8579524
10819805
10819805
9659102
9248971
11790022

In a block 914, the block to be coded, being of a size of 16×16 pixels, is fetched and stored in the left upper corner of the matrix of 48×48 elements. The other matrix elements are set to be zero. The block in the matrix is flipped in the horizontal and vertical directions in accordance with the principle shown in FIG. 7.

In the block 916, each column and row in the matrix is permuted in the same way as in the block 904. After this, the columns are multiplied by matrix A48 (which corresponds to the multiplication of a permuted matrix by matrix A48 from the left). Permutation and multiplication by matrix A48 can, in practice, be performed as one operation for the sake of efficiency.

TABLE 2

| ORIGINAL | NEW |
|---|---|
| 0 | 0 |
| 27 | 1 |
| 38 | 2 |
| 1 | 3 |
| 28 | 4 |
| 39 | 5 |
| 2 | 6 |
| 29 | 7 |
| 40 | 8 |
| 3 | 9 |
| 30 | 10 |
| 41 | 11 |
| 4 | 12 |
| 31 | 13 |
| 42 | 14 |
| 5 | 15 |
| 16 | 16 |
| 43 | 17 |
| 6 | 18 |
| 17 | 19 |
| 44 | 20 |
| 7 | 21 |
| 18 | 22 |
| 45 | 23 |
| 8 | 24 |
| 19 | 25 |
| 46 | 26 |
| 9 | 27 |
| 20 | 28 |
| 47 | 29 |
| 10 | 30 |
| 21 | 31 |
| 32 | 32 |
| 11 | 33 |
| 22 | 34 |
| 33 | 35 |
| 12 | 36 |
| 23 | 37 |
| 34 | 38 |
| 13 | 39 |
| 24 | 40 |
| 35 | 41 |
| 14 | 42 |
| 25 | 43 |
| 36 | 44 |
| 15 | 45 |
| 26 | 46 |
| 37 | 47 |

In a block 918, the columns received as a result from the previous block are multiplied by diagonal matrix D48. This corresponds to multiplication of matrix elements by coefficients, such as in the block 908.

In a block 920, the columns are multiplied by matrix B48. The blocks 916, 918 and 920 perform together in principle number-theoretic transform of the columns, except that the result is left in the permuted order.

TABLE 5

| | | |
|---|---|---|
| 16427629 | 524286 | 7077533 |
| 16427629 | 524286 | 7077533 |
| 16427629 | 524286 | 7077533 |
| 16427629 | 524286 | 7077533 |
| 16427629 | 524286 | 7077533 |
| 10123746 | 1591534 | 16182185 |
| 10123746 | 1591534 | 16182185 |
| 5293798 | 8836456 | 5192477 |
| 9100203 | 11515425 | 16143025 |
| 1487393 | 6157487 | 11019082 |
| 1219356 | 14948119 | 4384515 |
| 1219356 | 14948119 | 4384515 |
| 1219356 | 14948119 | 4384515 |
| 9910784 | 1910977 | 9549217 |
| 9910784 | 1910977 | 9549217 |
| 4692105 | 1350419 | 7145619 |
| 14836846 | 11299037 | 6928994 |
| 7443903 | 13999875 | 4443079 |

In a block 922, the rows are multiplied by a matrix A48 (which corresponds to multiplication from the right by transpose of matrix A48). In a block 924, the rows of the matrix received as a result from the previous block are multiplied by diagonal matrix D48.

In a block 926, the rows are multiplied by matrix B48. The blocks 922, 924 and 926 perform together in principle number-theoretic transform, except that the result is left in the permuted order.

In a block 928, the matrix elements that are in the wrong order, received from the blocks 912 and 926, are arranged in the right order and subsequently permuted. The right order is received from Table 2 and the permutation from Table 1. These two successive operations can be combined into one permutation of a new kind. In addition, the elements corresponding to each other in two matrices are multiplied by each other. For example, the matrix element received from the block 912 at location 5, 8 is multiplied by the matrix element 5,8 received from the block 926.

In a block 930, the result of the block 928 is multiplied from the left by matrix A48. In a block 932, the matrix is multiplied from the right by matrix B48.

In a block 934, the result of the previous block is multiplied both from the right and from the left by diagonal matrix E48. The diagonal values depend on the transform kernel used. In this example, they are received from Table 5. Two diagonal values can be multiplied together beforehand, in which case multiplication is saved per each matrix element.

In a block 936, the matrix is multiplied from the left by matrix B48. In a block 938, multiplication is performed from the right by matrix A48, and the matrix elements that are received as a result are arranged in accordance with Table 2. The blocks 930, 932, 934, 936 and 938 perform together inverse number-theoretic transform.

The matrix received as a result has in the left upper corner, in the area of 32×32 elements, correlation between the search area block 306 and the block 302 to be coded. In a block 940, this correlation is used in the computation of the cost function, i.e. as Term 4 in Formula 1.

Multiplication by matrices A3, A16, B3 and B16 can be performed with optimised algorithms. When multiplying the matrix from the right, algorithms deduced for transposes of constant matrices are used. These algorithms are given in the following. Deviating from the previous text, the indices of the algorithms given begin from one (and not zero).

Matrix A3:

t1=x(2)+x(3);

y(1)=x(1)+t1;

y(2)=t1;

y(3)=x(2)−x(3);

Matrix B3:

s1=x(1)+x(2);

y(1)=x(1);

y(2)=s+x(3);

y(3)=s1−x(3);

Transpose of matrix A3:

t1=x(1)+x(2);

y(1)=x(1);

y(2)=t1+x(3);

y(3)=t1−x(3);

Transpose of matrix B3:

s1=x(2)+x(3);

y(1)=x(1)+s1;

y(2)=s1;

y(3)=x(2)−x(3);

Matrix A16:

t1=x(1)+x(9);

t2=x(5)+x(13);

t3=x(3)+x(11);

t4=x(3)−x(11);

t5=x(7)+x(15);

t6=x(7)−x(15);

t7=x(2)+x(10);

t8=x(2)−x(10);

t9=x(4)+x(12);

t10=x(4)−x(12);

t11=x(6)+x(14);

t12=x(6)−x(14);

t13=x(8)+x(16);

t14=x(8)−x(16);

t15=t1+t2;

t16=t3+t5;

t17=t15+t16;

t18=t7+t11;

t19=t7−t11;

t20=t9+t13;

t21=t9−t13;

t22=t18+t20;

t23=t8+t14;

t24=t8−t14;

t25=t10+t12;

t26=t12−t10;

y(1)=t17+t22;

y(2)=t17−t22;

y(3)=t15−t16;

y(4)=t1−t2;

y(5)=x(1)−x(9);

y(6)=t19−t21;

y(7)=t4−t6;

y(8)=t24+t26;

y(9)=t24;

y(10)=t26;

y(11)=t18−t20;

y(12)=t3−t5;

y(13)=x(5)−x(13);

y(14)=t19+t21;

y(15)=t4+t6;

y(16)=t23+t25;

y(17)=t23;

y(18)=t25;

Matrix B16:

s1=x(4)+x(6);

s2=x(4)−x(6);

s3=x(12)+x(14);

s4=x(14)−x(12);

s5=x(5)+x(7);

s6=x(5)−x(7);

s7=x(9)−x(8);

s8=x(10)−x(8);

s9=s5+s7;

s10=s5−s7;

s11=s6+s8;

s12=s6−s8;

s13=x(13)+x(15);

s14=x(13)−x(15);

s15=x(16)+x(17);

s16=x(16)−x(18);

s17=s13+s15;

s18=s13−s15;

s19=s14+s16;

s20=s14−s16;

y(1)=x(1);

y(2)=s9+s17;

y(3)=s1+s3;

y(4)=s12−s20;

y(5)=x(3)+x(11);

y(6)=s11+s19;

y(7)=s2+s4;

y(8)=s10−s18;

y(9)=x(2);

y(10)=s10+s18;

y(11)=s2−s4;

y(12)=s11−s19;

y(13)=x(3)−x(11);

y(14)=s12+s20;

y(15)=s1−s3;

y(16)=s9−s17;

Transpose of Matrix A16:

t1=x(1)+x(2);

t2=x(1)−x(2);

t3=x(3)+x(4);

t4=x(3)−x(4);

t5=x(7)+x(3);

t6=x(7)−x(3);

t7=x(6)+x(8);

t8=x(8)−x(6);

t9=t1+t3;

t10=t2+t7+x(9);

t11=t1+t6;

t12=t2−t7−x(10);

t13=t1+t4;

t14=t2+t8+x(10);

t15=t1−t5;

t16=t2−t8−x(9);

t17=x(11)+x(14);

t18=x(14)−x(11);

t19=x(15)+x(12);

t20=x(15)−x(12);

t21=x(17)+x(16);

t22=x(16)+x(18);

t23=t21+t17;

t24=t22+t18;

t25=t22−t18;

t26=t21−t17;

y(1)=t9+x(5);

y(2)=t10+t23;

y(3)=t11+t19;

y(4)=t12+t24;

y(5)=t13+x(13);

y(6)=t14+t25;

y(7)=t15+t20;

y(8)=t16+t26;

y(9)=t9−x(5);

y(10)=t16−t26;

y(11)=t15−t20;

y(12)=t14−t25;

y(13)=t13−x(13);

y(14)=t12−t24;

y(15)=t11−t19;

y(16)=t10−t23;

Transpose of Matrix B1 6:

s1=x(2)+x(16);

s2=x(2)−x(16);

s3=x(3)+x(15);

s4=x(3)−x(15);

s5=x(4)+x(14);

s6=x(4)−x(14);

s7=x(6)+x(12);

s8=x(6)−x(12);

s9=x(7)+x(11);

s10=x(11)−x(7);

s11=x(10)+x(8);

s12=x(10)−x(8);

s13=s1+s11;

s14=s1−s11;

s15=s2+s12;

s16=s2−s12;

s17=s5+s7;

s18=s5−s7;

s19=s8−s6;

s20=s8+s6;

y(1)=x(1);

y(2)=x(9);

y(3)=x(5)+x(13);

y(4)=s3+s9;

y(5)=s13+s17;

y(6)=s3−s9;

y(7)=s13−s17;

y(8)=s18−s14;

y(9)=s14;

y(10)=−s18;

y(11)=x(5)−x(13);

y(12)=s4+s10;

y(13)=s19+s15;

y(14)=s4−s10;

y(15)=s15−s19;

y(16)=s16+s20;

y(17)=s16;

y(18)=−s20;

Instead of the described 48-point Winograd Fourier Transformation algorithm adapted for number-theoretic transform, the 24-point Winograd Fourier Transformation adapted for number-theoretic transform can be used. In such a case, the modulus and the kernel of the number-theoretic transform must be selected appropriately. Then, the block to be coded is padded to be of a size of 24×24 pixels by adding zero elements.

The methods described are performed in the encoder shown in FIG. 2 by using the motion estimation block 216, and if needed, also other blocks relating to the motion estimation vector 216, such as the block 220. The blocks of the encoder 102 shown in FIG. 2 can be implemented as one or several application-specific integrated circuits (ASIC). Also other kinds of implementations are feasible, for instance a circuit composed of separate logic components, or a processor with software. Also a combination of different implementations is possible. A person skilled in the art takes into account the requirements set by the size and power consumption of the device, the required processing efficiency, manufacturing costs and scale of production.

Although the invention has been described above with reference to the example according to the attached drawings, it is obvious that the invention is not confined thereto but can vary in a plurality of ways within the inventive idea of the attached claims. Thus, the size of the images to be processed can deviate from the cif size used in the example, and this will not cause significant changes in the implementation of the invention. Also the size of the block to be coded and the size of the search area can be changed from what is described in the examples, and still, the invention can be implemented by using number-theoretic transforms. In the examples, the block size is 16×16 and the search area size is 48×48, but also block sizes of 8×8 and 8×16 as well as a search area size of 24×24, for example, can be used. According to the Applicant's research, the modulus and kernel values presented in the example are good, but it is probable that also other suitable values exist. For example, the modulus value can be a prime number, which contains in the binary form as few number ones as possible. Also Fermat's number (2³²+1) can be used, but it requires a 33-bit memory, while memories usually have 32 bits.

1. A method of coding successive images, comprising
defining (600) a search area in a reference image, from which search area the block to be coded in the present image is searched;
computing (602) the cost function of each motion vector candidate, which motion vector candidate determines the motion between the block to be coded and the candidate block in the search area;
coding (614) the block to be coded by using the motion vector candidate giving the lowest cost function value;
characterized in that in the computation (602) of the cost function
number-theoretic transform is performed (604) for the block to be coded;
number-theoretic transform is performed (606) for the candidate block;
multiplication is performed (608) between the block to be coded and the transformed candidate block;
correlation between the block to be coded and the candidate block is formed (610) by performing inverse transform of number-theoretic transform for the result of the multiplication; and
the correlation formed is used (612) in the computation of the cost function.

2. A method according to claim 1, characterized by the number-theoretic transform being implemented by using the Radix-2 algorithm.

3. A method according to claim 1, characterized by the number-theoretic transform being implemented by using the Winograd Fourier Transformation algorithm (WFTA).

4. A method according to claim 1, characterized by the modulus of the number-theoretic transform being 16777217 and the kernel being 524160, or the modulus being 16777217 and the kernel being 65520, or the modulus being 4294967297 and the kernel being 4, or the modulus being 4294967297 and the kernel being 3221225473.

5. A method according to claim 1, characterized in that in the computation (602) of the cost-function
the block to be coded is padded to the size in which one pixel corresponds to each motion vector candidate by adding zero elements; and
the block to be coded is flipped in the horizontal and vertical directions.

6. A method according to claim 2, characterized in that in the computation (602) of the cost function
at least four transformed candidate blocks are selected, and multiplication is performed for each of them in turn by the flipped, transformed block to be coded, and inverse transform of number-theoretic transform is performed for each result of the multiplication, the results of the inverse transform being combined into one correlation.

7. A method according to claim 6, characterized by the number-theoretic transform of the block to be coded being performed first for the left half of all columns and after that for all rows.

8. A method according to claim 6, characterized by the inverse transform of the number-theoretic transform being performed first for all rows and after that for the left half of all columns.

9. A method according to claim 1, characterized by the number-theoretic transform being implemented by using the 48-point Winograd Fourier Transformation algorithm adapted for number-theoretic transform or the 24-point Winograd Fourier Transformation algorithm adapted for number-theoretic transform.

10. A method according to claim 9, characterized by the modulus of the number-theoretic transform being 16777153 and the kernel being 4575581.

11. A method according to claim 9, characterized by the block to be coded being padded to the size of 48×48 pixels or 24×24 pixels by adding zero elements.

12. A method according to any one of previous claims, characterized by using the SSD (Sum of Squared Differences) as the cost function.

13. A device for coding successive images, comprising
means (216) for determining the search area in the reference image, from which search area the block to be coded in the present image is searched;
computing means (216) for computing the cost function of each motion vector candidate, which motion vector candidate determines the motion between the block to be coded and the candidate block in the search area;
means (216, 220) for coding the block to be coded by using the motion vector candidate giving the lowest value of the cost function;
characterized in that the computing means (216) perform number-theoretic transform for the block to be coded;
perform number-theoretic transform for the candidate block;
perform multiplication between the transformed block to be coded and the transformed candidate block;
form correlation between the block to be coded and the candidate block by performing inverse transform of number-theoretic transform for the result of the multiplication; and
use the correlation formed in the computation of the cost function.

14. A device according to claim 13, characterized in that the computing means (216) implement number-theoretic transform by using the Radix-2 algorithm.

15. A device according to claim 13, characterized in that the computing means (216) implement number-theoretic transform by using the Winograd Fourier Transformation algorithm (WFTA).

16. A device according to claim 13, characterized in that in the computing means (216) the modulus of the number-theoretic transform is 16777217 and the kernel 524160, or the modulus is 16777217 and the kernel 65520, or the modulus is 4294967297 and the kernel 4, or the modulus is 4294967297 and the kernel 3221225473.

17. A device according to claim 13, characterized in that the computing means (216) in the computation of the cost function
pad the block to be coded to a size in which one pixel corresponds to each motion vector candidate by adding zero elements; and
flip the block to be coded in the horizontal and vertical directions.

18. A device according to claim 14, characterized in that the computing means (216) in the computation of the cost function
select at least four transformed candidate blocks, for each of which in turn they perform multiplication by the flipped, transformed block to be coded, and for each result of the multiplication in turn they perform inverse transform of number-theoretic transform, combining the results of the inverse transform into one correlation.

19. A device according to claim 18, characterized in that the computing means (216) perform number-theoretic transform of the block to be coded first for the left half of all columns and then for all rows.

20. A device according to claim 18, characterized in that the computing means (216) perform inverse transform of number-theoretic transform first for all rows and then for the left half of all columns.

21. A device according to claim 13, characterized in that the number-theoretic transform is implemented by using the 48-point Winograd Fourier Transformation algorithm adapted for number-theoretic transform or the 24-point Winograd Fourier Transformation algorithm adapted for number-theoretic transform.

22. A device according to claim 21, characterized in that in the computing means (216) the modulus of the number-theoretic transform is 16777153 and the kernel is 4575581.

23. A device according to claim 21, characterized in that the computing means (216) pad the block to be coded to the size of 48×48 pixels or 24×24 pixels by adding zero elements.

24. A device according to any one of previous claims 13 to 23, characterized in that the computing means (216) use the SSD (Sum of Squared Differences) function as the cost function.
